(19) United States
(12) Patent Application Publication
(10) Pub. No.: US 2013/0342535 A1
(43) Pub. Date: Dec. 26, 2013

(54) Hierarchical Tree Traversal in Graphics Pipeline Stages

(71) Applicants: Sebastian Kevin Sylvan, Seattle, WA (US); Michael George Boulton, Seattle, WA (US)

(72) Inventors: Sebastian Kevin Sylvan, Seattle, WA (US); Michael George Boulton, Seattle, WA (US)

(73) Assignee: MICROSOFT CORPORATION, Redmond, WA (US)

(21) Appl. No.: 13/528,419

(22) Filed: Jun. 20, 2012

(51) Int. Cl. G06T 15/80; G06T 1/00

(52) U.S. Cl. 345/426; 345/418

(57) ABSTRACT

Described is a technology by which a hierarchical tree structure is traverses at different stages in a graphics pipeline, in a coarse-to-fine fashion. In one aspect, each relevant coarser pipeline stage in the GPU pipeline traverses the tree until stopped by the “coarseness” of that pipeline stage, and passes the state of the traversal to the next (finer-grained) stage, for a finer traversal, and so on as needed. The technology links the hierarchical coarse-to-fine nature of the graphics pipeline to the hierarchical coarse-to-fine nature of the tree structure.

### BACKGROUND

Many algorithms on a graphics processing unit (GPU) may benefit from doing a query in a hierarchical tree structure (including quad-trees, oct-trees, kd-trees, R-trees, and so forth). However, these trees can be very deep, whereby traversing the tree uses many fetches from memory to reach the “leaf” node where the data typically resides. For example, to traverse a tree in the pixel shader, the traversal typically starts at the root of the tree, with many memory fetches needed to work down to a leaf to retrieve the actual data for the query point.

Consider a scenario in which lightmap data is stored in a sparse quad-tree instead of using a traditional texture map; in such a tree, the empty areas of the texture take up no memory, and areas of low variance can use lower resolutions. An algorithm may query lightmap data in the pixel shader, replacing a traditional texture map lookup. The pixel shader queries the 2D quad-tree using a UV-coordinate as with normal 2D textures. If a hypothetical quad tree covers the equivalent of a typical high definition screen resolution and the total depth of the tree is twelve, e.g. 1920×1080 multiplied by 12 fetches per pixel=24,883,200. This is a significant computational expense, and any reduction in the number of fetches needed to locate needed data is highly desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a hierarchal tree of nodes is traversed by stages a graphics pipeline, including a first stage having a first traversal mechanism configured to traverse at least some of a hierarchical tree structure of data in a coarse traversal until a first state is detected. A second traversal mechanism traverses at least some of the hierarchical tree structure in a fine traversal (relative to the coarse traversal) until a second state is detected, in which the fine traversal uses state information from the coarse traversal to avoid traversing at least some nodes traversed in the coarse traversal. One or more additional stages corresponding to additional coarseness and/or fineness may be present in the pipeline and traverse the tree in coarse-to-fine traversal operations.

In one aspect, a higher stage in a graphics pipeline traverses a hierarchal tree structure in a higher stage traversal until a stopping criterion is met. State information corresponding to the higher stage traversal is provided to a lower stage in the graphics pipeline. The lower stage, upon receiving the state information, uses the state information to determine one or more starting points for a lower stage traversal, which comprises traversing the hierarchal tree of nodes based upon the one or more starting points until another stopping criterion is met.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a graphics pipeline configured for coarse-to-fine tree traversal of a hierarchical tree, according to one example embodiment.

FIG. 2 is an example representation of a graphics patch primitive having data represented in nodes of a hierarchical quad tree structure, according to one example embodiment.

FIG. 3 is an example representation of a graphics geometry primitive having data represented in nodes of a hierarchical quad tree structure, according to one example embodiment.

FIGS. 4A and 4B comprise a representation of a quad primitive at different zoom levels, according to one example embodiment.

FIG. 5 is a flow diagram representing example steps that may be taken to traverse a hierarchical tree with three coarser-to-finer stages corresponding to a patch-level traversal, a geometry-level traversal and a pixel-level traversal, according to one example embodiment client.

FIG. 6 is a block diagram representing an example computing environment into which aspects of the subject matter described herein may be incorporated.

### DETAILED DESCRIPTION

Various aspects of the technology described herein are generally directed towards performing parts of tree traversal at different stages in the graphics pipeline, in a coarse-to-fine fashion. In one aspect, each coarser stage in the GPU pipeline does as much of the tree-traversal as possible (limited by the “coarseness” of that pipeline stage), and passes on the intermediate state of the traversal to the next (finer-grained) stage, which refines it further. As will be understood, the technology exploits the hierarchical coarse-to-fine nature of the graphics pipeline, by linking it to the hierarchical coarse-to-fine nature of the trees.

In general, the technology herein leverages pixel-to-pixel coherency, in which two adjacent pixels represented in a tree structure are likely to share a large portion of the path from the root, to avoid repeating work for each pixel. For example, moving some of the traversal work to the geometry shader stage of the graphics pipeline (which runs per-triangle, instead of per-pixel) instead of having the pixel shader stage perform the entire traversal, results in considerable work being shared for pixels.

It should be understood that any of the examples herein are non-limiting. For one, while examples are described in the hierarchical nature of object rendering on a GPU, a similar strategy may be employed for more general tasks, for three-dimensional or two-dimensional objects, and/or for various types of hierarchical tree structures. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and tree traversal in general.

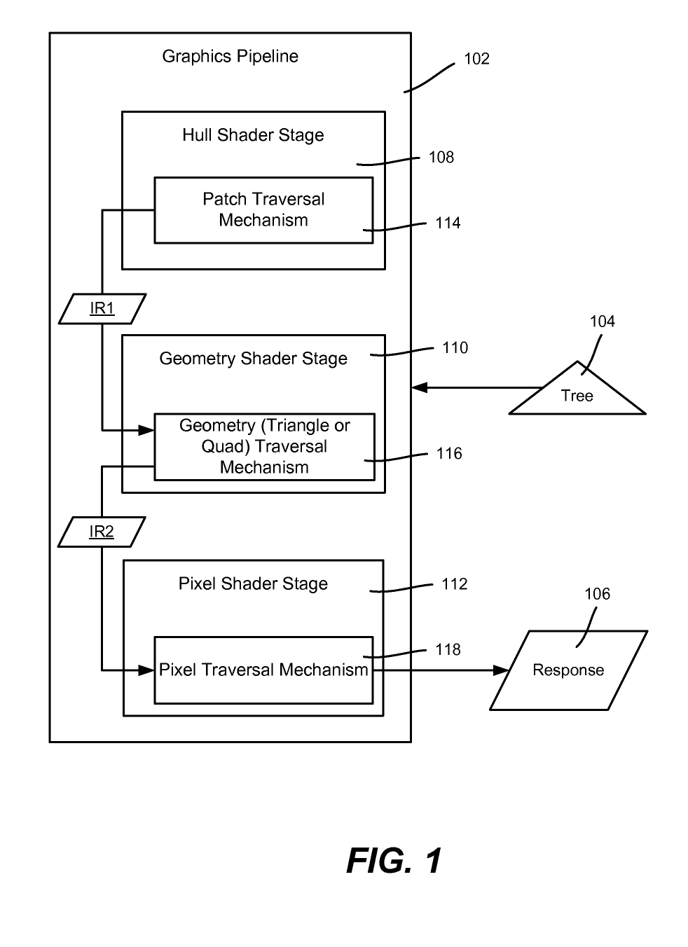

FIG. 1 shows a block diagram comprising components of an example graphics pipeline 102 that is configured to traverse a tree 104 and return results in a response (e.g., a query response) 106. Note that for simplicity, only certain example stages of the graphics pipeline are shown in FIG. 1; exemplified are a hull shader stage 108, a geometry shader stage 110, and a pixel shader stage 112. For example, contemporary GPUs can process larger primitives (called “patches”) than geometry primitives (quad or triangle primitives); such patch processing corresponds to the hull shader stage of FIG. 1. Other stages, e.g., a vertex shader stage, a tessellator stage, a domain shader stage, and rasterizer stage may be present in a given implementation, and may benefit from the concepts described herein.

The illustrated stages 108, 110 and 112 are programmed to each contain a traversal mechanism, represented by blocks 114, 116 and 118, respectively. The stages can communicate data to one another, such that a higher level traversal mechanism is able to pass intermediate state results (IR1 or IR2) to the next lower traversal mechanism.

As generally described herein, in an implementation with patch-processing capabilities, some of the traversal may be performed on the patch by the patch traversal mechanism 114, with the resulting intermediate state results IR1 (e.g., comprising a starting node or nodes for that next level) passed down to the geometry traversal mechanism 116.

In general, the patch traversal mechanism traverses the tree downwards, until a node is reached that no longer contains the entire patch data under that node. This can be stated as detecting child nodes that intersect. The intermediate state may correspond to one or more nodes, with a predetermined threshold set for when to stop traversing, e.g., stop once there are more than N nodes (typically a relatively small number) that intersect, and send state information comprising the parent node or all the child nodes (if N was set to one), or the appropriate subset of child nodes that intersect if N is greater than one. The next stage in the hierarchy loops through paths starting with the node or nodes passed, thereby ignoring ones not intersected, and traversing nodes that intersect). Note that in less structured trees where child nodes can overlap (e.g. bounding-box trees), it is common for a region to touch more than one child node, whereby sending multiple nodes may be beneficial.

As can be readily appreciated, depending on the exact type of tree used, it also may be beneficial to have some of the nodes, particularly near the root, be “loose,” such that the children overlap slightly. This avoids having to stop traversal early because a primitive slightly overlaps child nodes.

When the intermediate state is received in the example of FIG. 1 wherein the next stage is the geometry shader stage 110, the geometry traversal mechanism 116 does further traversal on the quad or triangle primitive, until intersection is detected. Note that the number of intersecting nodes that stop traversal at this stage need not be the same as the number at the higher stage. When traversal is stopped, the geometry traversal mechanism 116 passes down the intermediate results IR2 to the pixel traversal mechanism 118, which starts its traversal at the passed node or nodes and traverses down to the leaf node. As is understood, even if starting the whole traversal operation at the geometry shader stage (in an implementation without patch-processing capabilities, for example), benefits are obtained because the geometry shader stage is coarser than the pixel shader stage.

As can be readily appreciated, the technology may be used at any relevant hierarchical levels. Further, coarse-to-fine traversal also may be extended above the patch processing stage. For example, if dealing with a tree whose root node covers more than just one object, some tree traversal on the CPU may be performed.

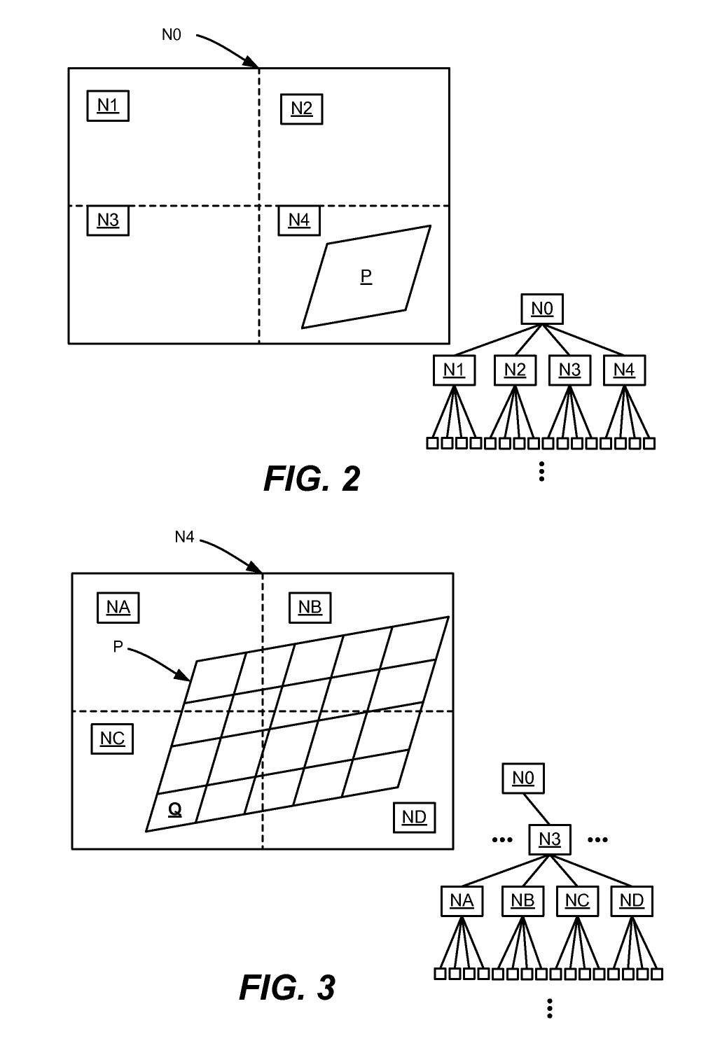

Turning to an example, consider processing a sparse quad-tree as generally represented in FIGS. 2-4A. A suitable example tree may be considered in which on average there are about 8×8 pixels per triangle, such that a quad-tree needs about three levels to cover a whole triangle. If the tessellator stage (between the hull shader stage and the geometry shader stage) outputs, on average, about 16×16 triangles per patch, then four levels are needed to cover the entire patch. If the quad tree covers the equivalent of 4090×4096 pixels, then the total depth is twelve.

Instead of starting traversal at the pixel shader stage, described herein is first performing a tree traversal at a higher stage, e.g., on the “patch” in FIG. 1, before tessellation. Traversal continues as far down the tree as possible until the patch is no longer entirely covered by a child node, that is, intersection is detected. Consider in this example that traversal stops at the first detected intersection.

This is represented in FIGS. 2 and 3, in which there is a patch P intersecting against the root node N0 of a quad-tree. In this patch processing part of the example, the patch P's representative data is contained entirely within the lower-right child node N4 of the root node N0, so the query process continues traversing down into that child node N4.

FIG. 3 is a zoomed-in representation of the lower-right child node N4. At this level, the patch P is not covered entirely by one child node, and thus no further traversal is performed at the patch-level.

Note that in the example of FIGS. 2-4A, the size of the patch P is exaggerated to facilitate illustration, so that there is one traversal step in each of the patch and geometry (quad/triangle) stages. In a typical actual tree, there are likely more traversal steps in these stages, (whereby more operations can be skipped in the final pixel shader stage).

As described herein, the patch traversal mechanism sends the intermediate state (node N4's information) down for processing each tessellation primitive at the geometry shader stage. Note that the primitives in FIG. 3 are represented as quads, however they instead may be triangles, for example.

In FIG. 3, consider the quad geometry primitive labeled Q. In the geometry shader stage 110, this quad Q is intersected against the node NC. Because the quad Q is entirely covered by the lower left quad-tree child node NC, that child node NC can be traversed by the geometry traversal mechanism 116.

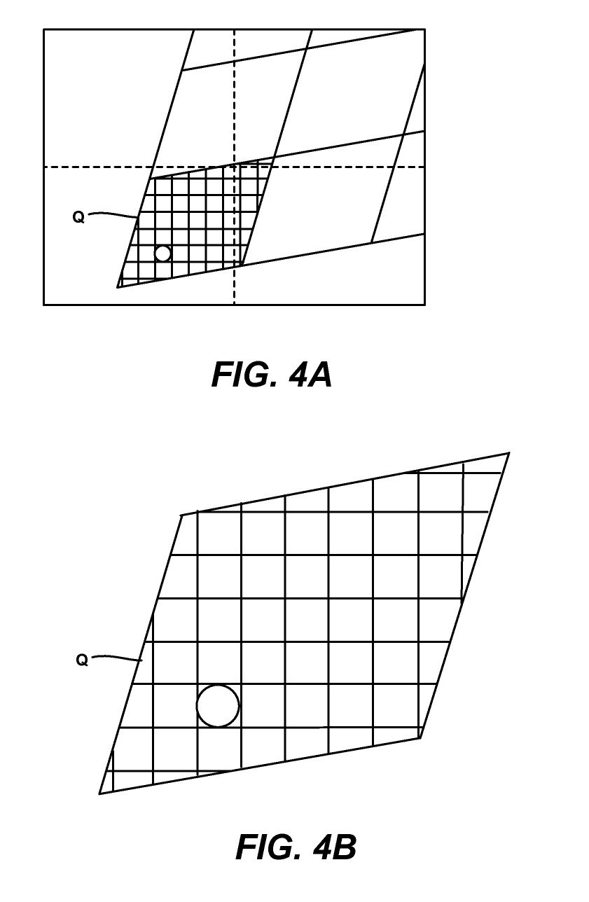

FIGS. 4A and 4B focus on the lower-left quad Q; FIG. 4B is a zoomed in representation of FIG. 4A. As can be seen, at this level the quad Q is no longer entirely covered by a single child node, so no more traversal can be performed in the geometry shader stage 110, and the current traversal state information is sent down to the pixel traversal mechanism 118.

FIG. 4B is zoomed-in to represent the lower-left child of the previous node in a more easily viewed manner. The pixel traversal mechanism 118 of the pixel shader stage 112 traverses the individual pixels of the quad Q down to the leaf node of the tree, to retrieve the requested data to return as the query results 106.

In the example twelve-level tree described above (about 8×8 pixels per triangle, about 16×16 triangles per patch), the per-patch traversal needs 12−4−3=5 fetches. Thus, the total number of fetches in coarse-to-fine processing may be five for the patch, then four for each of the 16×16 triangles in the patch, and then three for each of the 8×8 pixels in each triangle, totaling 50,181 fetches for the whole patch.

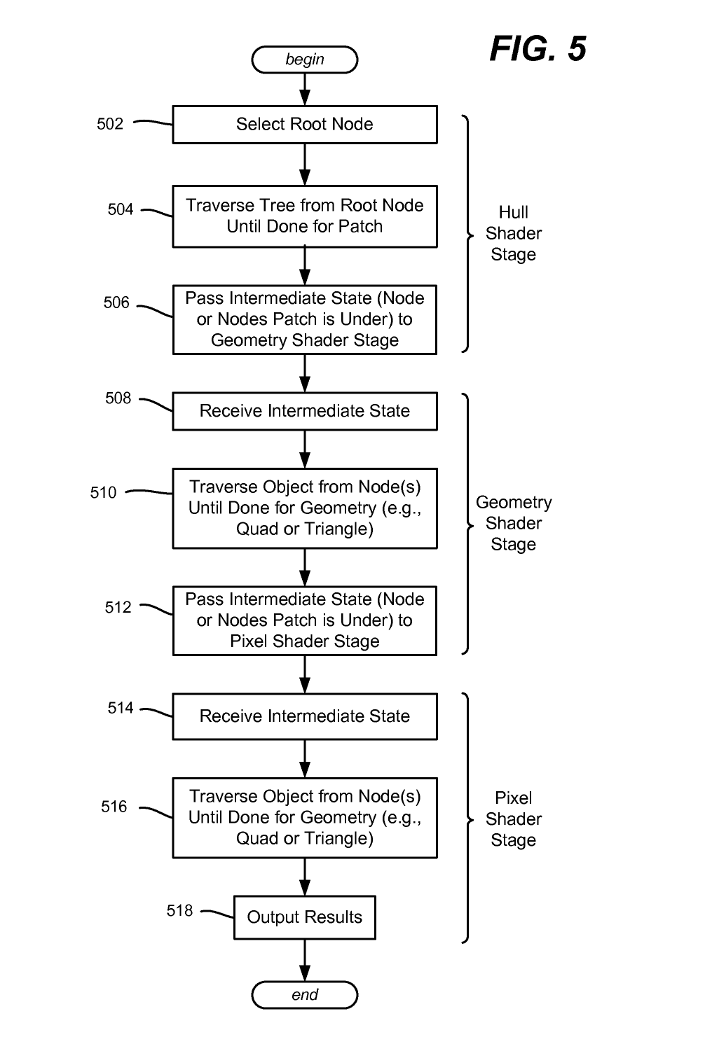

FIG. 5 is a flow diagram showing example steps taken to traverse a tree in a coarse-to-fine manner corresponding to the coarse-to-fine stages of a graphics pipeline. In the example of FIG. 5, traversal starts at the patch level.

At steps 502 and 504, the patch traversal mechanism starts at the root node and traverses the nodes of the tree to find a lowest child node or (subset of child nodes) that contains the data of an entire patch under that node. When this node or subset of nodes is reached, at step 506 corresponding state information is passed (e.g., an identity of each node or nodes) to the geometry shader stage. Note that in the above exaggerated example of FIG. 2 this was only one child level lower, however with smaller patches in an actual, typical tree, the resolution is such that more than one lower node level typically will be reached in patch traversal, particularly if “loose” nodes are used.

With respect to such “loose” nodes, many types of tree structures may be tweaked with some amount of “looseness” to avoid having to stop traversal early on the coarse stages of the pipeline. For example, if a triangle barely intersects both children while traversing the tree in the geometry shader, instead of ending the traversal and performing the remaining traversal in the pixel shader, a tree with some looseness may have a child that entirely covers the triangle, even though other children intersect the triangle, whereby the process may continue traversing for at least one more level. Thus, instead of detecting intersection, the stopping criterion rule corresponds to whether a child node (or subset of nodes) contains the entire triangle data, regardless of whether there is some other intersection.

Steps 508, 510 and 512 are similar to steps 502, 504 and 506 and are not separately described, except to note that the geometry shader performs them on appropriate primitives, and that the traversal stopping criterion or rule may differ from that of the higher level. During the traversal, the paths taken by the geometry shader can start at the node (or set of nodes) passed to it from the higher level, because the entire patch of primitives is known to be under that node or subset of nodes.

Step 514 represents the pixel shader stage receiving the state information passed from the higher, geometry shader stage. Step 516 traverses the pixels starting from each node (which may be a single node) for each path taken. Step 518 outputs the results when the pixel traversal completes.

In sum, each level determines a lowest node or subset of child nodes during traversal that contains the primitive's data for that level, and passes that state information to the next lowest level. For example, the geometry shader, which may act on individual triangles or quads, keeps traversing until the triangle or quad is no longer entirely covered by a child node. Then the last-fully-covering node or set of nodes is passed on to the pixel shader, which traverses from that node (or each node of the set) down to the leaf nodes and retrieves the requested data.

Note that the above-described coarse-to-fine technology was only one example, and the technology is applicable to any hierarchical structure to be queried in a coherent fashion at one of the lower stages of the GPU pipeline. For example, a domain shader tree-lookup may be sped up by doing some traversal in the patch-level, in an analogous way. Other trees instead of a 2D quad-tree (e.g., queried by a traditional UV coordinate) may be similarly traversed, e.g., a 3D oct-tree may instead be traversed, using the world space position to query data. Other types of trees may be used to facilitate filtering (such as Random-Access trees), or others to achieve any other property of interest.

### Example Operating Environment

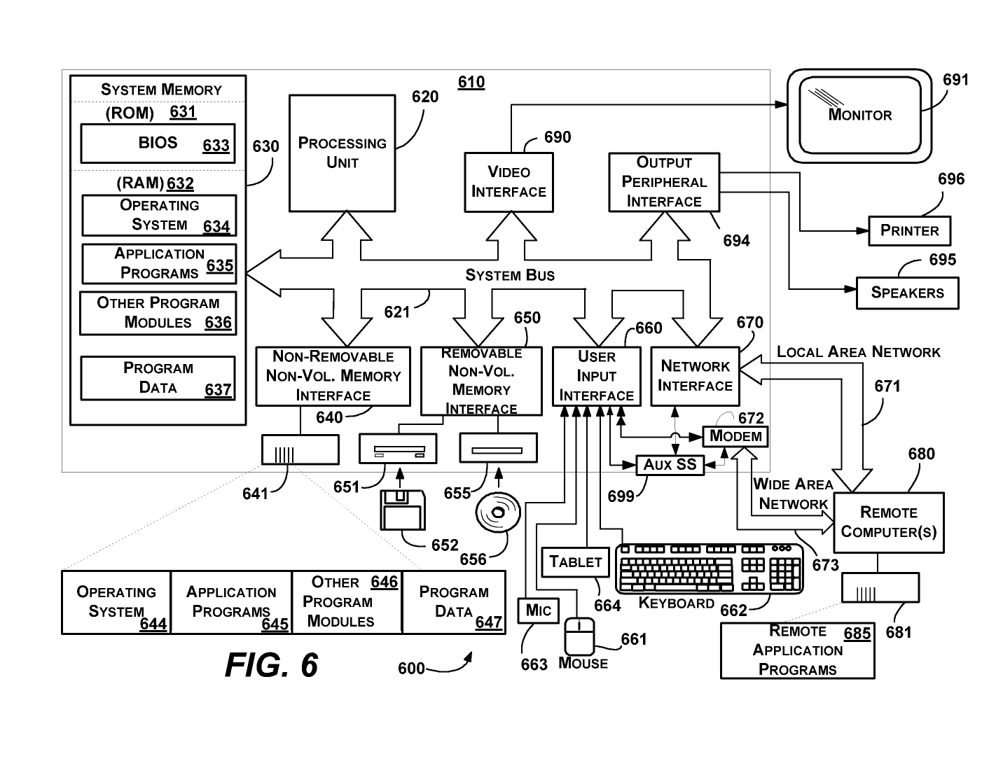

FIG. 6 illustrates an example of a suitable computing and networking environment 600 into which the examples and implementations of any of FIGS. 1-4 may be implemented, for example. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the example operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an example system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are examples and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-chip systems (SOCs), Complex Programmable Logic Devices (CPLDs), etc.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising:
in a higher stage in a graphics pipeline, traversing a hierarchal tree of nodes in a higher stage traversal until a stopping criterion is met;
providing state information corresponding to the higher stage traversal to a lower stage; and
in the lower stage in the graphics pipeline, receiving the state information, using the state information to determine one or more starting points for a lower stage traversal, and traversing the hierarchal tree of nodes in the lower stage traversal based upon the one or more starting points until another stopping criterion is met.

2. The method of claim 1 wherein the higher stage corresponds to a geometry shader stage, wherein the lower stage corresponds to a pixel shader stage, and wherein traversing the hierarchal tree of nodes in the lower stage until the other stopping criterion is met comprising traversing the hierarchical tree down to at least one leaf node is reached.

3. The method of claim 2 wherein the tree is processed based upon a query, and further comprising, returning a query response based upon data contained in a leaf node.

4. The method of claim 1 wherein the stopping criterion in the higher stage corresponds to a number of node intersections, and further comprising, detecting when the number of node intersections is reached during the traversal.

5. The method of claim 1 wherein the stopping criterion in the higher stage corresponds to reaching a lowest level node that contains the entire data representative of a graphics primitive under that lowest level node.

6. The method of claim 1 further comprising a pixel shader stage below the lower stage in the graphics pipeline, and further comprising, providing lower state information corresponding to the lower stage traversal to the pixel stage upon meeting the other stopping criterion in the lower stage traversal.

7. A system comprising, a graphics pipeline, including a first stage having a first traversal mechanism configured to traverse at least some of a hierarchical tree structure of data in a coarse traversal until a first state is detected, and a second stage having a second traversal mechanism configured to traverse at least some of the hierarchical tree structure in a fine traversal relative to the coarse traversal until a second state is detected, in which the fine traversal uses state information from the coarse traversal to avoid traversing at least some nodes traversed in the coarse traversal.

8. The system of claim 7 further comprising a third stage having a third traversal mechanism configured to traverse at least some of the hierarchical tree structure in an even finer traversal relative to the fine traversal until a third state is detected, in which the even finer traversal uses state information from the fine traversal to avoid traversing at least some nodes traversed in the fine traversal.

9. The system of claim 8 wherein the first stage corresponds to a shader stage for a patch primitive level shader, wherein the second stage corresponds to a shader stage for a geometry primitive level shader, and wherein the third stage corresponds to a shader stage for a pixel level shader.

10. The system of claim 7 wherein the first stage corresponds to a hull shader stage for a patch primitive, and the second stage corresponds to a geometry shader stage for a geometry primitive.

11. The system of claim 7 wherein the first stage comprises a geometry shader stage, and the second stage comprises a pixel shader stage.

12. The system of claim 7 wherein the first stage corresponds to a a patch-level primitive, and wherein the first state is reached when data corresponding to a patch is not contained under a single node.

13. The system of claim 7 wherein the first stage corresponds to a a patch-level primitive, and wherein the first state is reached when data corresponding to a patch intersects a predetermined number of nodes.

14. The system of claim 7 wherein the first stage corresponds to a a geometry-level primitive, and wherein the first state is reached when data corresponding to a geometry primitive is not contained under a single node.

15. The system of claim 7 wherein the first stage corresponds to a a geometry-level primitive, and wherein the first state is reached when data corresponding to a geometry primitive intersects a predetermined number of nodes.

16. The system of claim 7 wherein the second stage corresponds to a a pixel, and wherein the second state is reached when the traversal reaches at least one leaf node.

17. The system of claim 16 wherein the second stage returns a response based upon data contained in a leaf node.

18. One or more computer-readable media having computer-executable instructions, which when executed perform steps, comprising:
in a geometry stage in a graphics pipeline, traversing at least some of a hierarchal tree of nodes in a geometry stage traversal until a stopping criterion is met;
providing state information corresponding to the geometry stage traversal to a pixel shader stage; and
in the pixel shader stage, receiving the state information, using the state information to determine one or more starting points for another traversal operation, and traversing the hierarchal tree of nodes in the other traversal operation based upon the one or more starting points.

19. The one or more computer-readable media of claim 18 having further computer-executable instructions, comprising, in a stage above the geometry stage in the graphics pipeline, traversing a hierarchal tree of nodes in a higher stage traversal until a stopping criterion is met, and when the stopping criterion is met, providing state information from the higher stage to the geometry stage.

20. The one or more computer-readable media of claim 19 having further computer-executable instructions, comprising, in the geometry shader stage, receiving the state information from the higher stage, using the state information from the higher stage to determine one or more starting points for the geometry stage traversal.
